(19) United States
(12) Patent Application Publication
(10) Pub. No.: US 2006/0288221 A1
(43) Pub. Date: Dec. 21, 2006

(54) METHOD, APPARATUS, AND PROGRAM PRODUCT FOR RECONFIGURING A SOFTWARE PACKAGE

(76) Inventors: Tadashi Yamamoto, Yamato-shi (JP); Naoki Yamakoshi, Yamato-shi (JP)

Correspondence Address: HOFFMAN, WARNICK & D'ALESSANDRO LLC, 75 STATE ST, 14 FL, ALBANY, NY, 12207, US

(21) Appl. No.: 11/422,958

(22) Filed: Jun. 8, 2006

(30) Foreign Application Priority Data
Jun. 17, 2005 (JP) 2005-178382

(51) Int. Cl. H04L 9/00

(52) U.S. Cl. 713/176

(57) ABSTRACT

The present invention provides a method, an apparatus and a program for reconfiguring a package, by which, when a user reconfigures a software package from given components, the user can provide a client with a package guaranteed by a provider who provides a single package. A method for reconfiguring a software package, wherein a primary software package contains a plurality of components and combination information indicating allowed combinations of the components, includes: receiving a selection of a certain combination among the plurality of components; determining whether a reconfiguration of the software package using the selected components should be allowed based on the combination information; and reconfiguring a secondary software package containing the selected components in compliance with the determination.

### FIELD OF THE INVENTION

The present invention relates to a method, an apparatus, and a program for reconfiguring a software package, and more particularly to a method, an apparatus, and a program for reconfiguring a software package by combining software components used by a computer.

### BACKGROUND OF THE INVENTION

With the diversification of software products in recent years, there is a tendency of a software package to be composed of a large number of components. A software user, however, rarely uses all of the components and a vendor providing a software product is required to distribute a software package (hereinafter, appropriately referred to as “package”) including only components highly needed by clients.

Normally, when configuring an optimal package for a client, a vendor as a primary provider selects software programs (hereinafter, referred to as “components”) meeting the needs of the client for the package configuration.

For example, when a vendor provides an operating system as a package, required components depend upon languages provided by the operating system. Therefore, in most cases, components for one language appropriate for the client are selected out of English, Japanese, or French components and the entire combination of the selected components is provided as an individual package.

The creation of the individual package by the package provider on a case-by-case basis, however, leads to an increase in human and time costs for management, testing, and distribution of a large number of packages and for media creation. Therefore, there has been used a method in which a vendor provides a primary software package (hereinafter, referred to as “single package”) including all components that can be selected and a user selects components to be introduced at installation. This structure is often used at the time of distributing office applications.

Under the present situation, however, with the enhancement of the functions of software programs, there is a tendency of an increase in file size of the components constituting a single package and it leads to a large increase in size of the single package. In recent years, a software package is frequently distributed over a network such as the Internet. In distributing this type of single package over a network, there has been a tendency of an increase in load on a server performance or load on the network and in volume of the software package in the storage device of a server or a user.

Therefore, there has been suggested a method of distributing a single package over a network with a reduction of a load on a server or a network even if the single package size increases. See, for example, Japanese Laid-Open Patent Publication No. Hei 8(1996)-83245 and Japanese Laid-Open Patent Publication No. 2000-285048

Although the methods described in the above-cited references are useful to reduce load on a server and a network to some extent for distributing a gigantic single package, a network administrator or the like of a company temporarily records the package into an in-house server or the like in the case of such a large software package. Thereafter, a client downloads the package from the server for use in most cases. This technique, however, is ineffective to reduce the load on the in-house server or the network applied by the client.

In order to solve such a problem like this, one can use a method for taking out only required components from a single package, and thereby reconfiguring and redistributing a new package. However, in general, in order to prevent a malicious amendment, contamination of virus or the like, a software package is guaranteed by way of digital signature. For this reason, if a single package is acquired and then a mediator selects the given components at his/her discretion and reconfigures a package, it is judged that the package was reformed. Therefore, the package will lose the guarantee of a provider of the single package. Consequently, even if a mediator duly configures a package under the contract with the provider, a client who acquired the package having been provided by the mediator cannot obtain guarantees from the provider. As a result, the exploitation of the package itself becomes impossible. Therefore, even if there is any problem in the software product, it may be difficult to request any actions to the provider.

### SUMMARY OF THE INVENTION

The present invention provides a method, an apparatus and a program for reconfiguring a software package, by which a user such as a mediator or the like can provide a client with the reconfigured package whose legitimacy is guaranteed by a primary provider who provides a single package, when the user reconfigures a software package from given components.

Therefore, the present invention provides a method, an apparatus, and a program for reconfiguring a software package as described below.

According to the present invention, there are provided a method, an apparatus, and a program for reconfiguring a software package, wherein a primary software package contains a plurality of components and combination information on the allowed combination of the components, comprising: receiving a selection of a given combination among the plurality of components; determining whether or not the reconfiguration of the software package by the components of the selected combination should be allowed based on the combination information; and reconfiguring a secondary software package containing the components of the selected combination in compliance with judgment of whether or not the reconfiguration should be allowed.

Specifically, according to the present invention, when reconfiguring a software package with one or more components, the selection of the given components is received, the combination of the given components is determined based on the combination information on the allowed components, and the secondary software package containing the selected components is reconfigured based on the judgment.

Therefore, according to the present invention, the software package is reconfigured based on the combination information, which is information on the combination of the components for reconfiguration when reconfiguring the software package, whereby the secondary software package can be reconfigured based on the combination of the components allowed by the primary provider.

More specifically, the combination information is stored in the package with a digital signature appended and the legitimacy of the package is verified by way of the digital signature of the combination information in addition to the above structure. In this structure, it is possible to reconfigure the secondary software package under reliable guarantees from the primary provider for the combination information.

Still more specifically, the combination information may be carried over to the secondary software package in the step of reconfiguring in addition to the above structure. Therefore, the combination of the components allowed by the primary provider is thus carried over to the secondary provider without any change of the combination of the components allowed by the primary provider, whereby the allowing of the primary provider for the combination of the components can be carried over to low providers.

Therefore, according to the present invention, when a user as a secondary provider or the like reconfigures a software package including given components, it is possible to provide a method, an apparatus, and a program for reconfiguring a software package enabling providing a secondary provider to be the next provider and a client to be a final user with a package containing components of the combination guaranteed by a primary provider who provides a primary software package.

### BRIEF DESCRIPTION OF THE DRAWINGS

Embodiments of the present invention will now be described in detail hereinafter with reference to the accompanying drawings.

FIG. 1 is a functional block diagram of a package configuration apparatus.

FIG. 2 is a diagram showing a data structure of a single package.

FIG. 3 is a flowchart showing the main operation executed by the package configuration apparatus.

FIG. 4 is a flowchart showing package configuration processing executed by the package configuration apparatus.

FIG. 5 is a diagram showing a data structure of a private package.

FIG. 6 is a diagram showing combination data and combination signature.

FIG. 7 is a diagram showing a data structure of combination information.

FIG. 8 is a diagram showing a data structure of combination information.

### DETAILED DESCRIPTION OF THE INVENTION

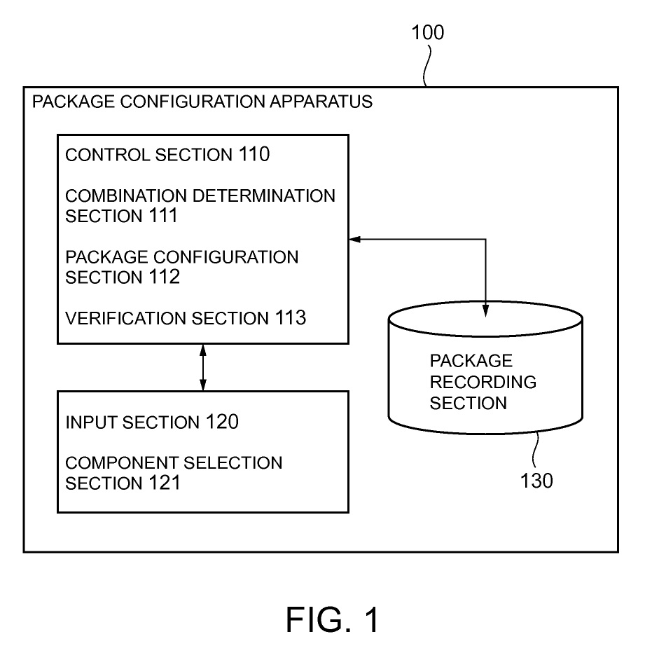

As shown in FIG. 1, a package configuration apparatus 100 includes a control section 110 for controlling information, an input section 120 for receiving an input from a user, and a package recording section 130 for recording a software package.

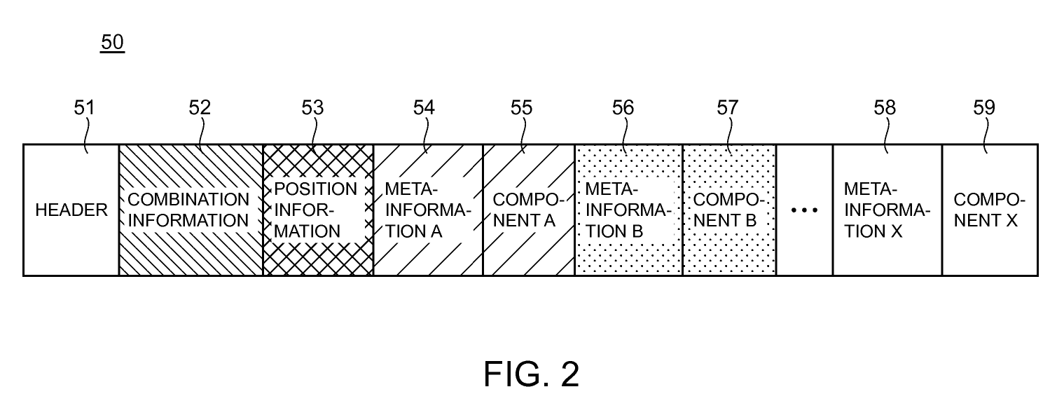

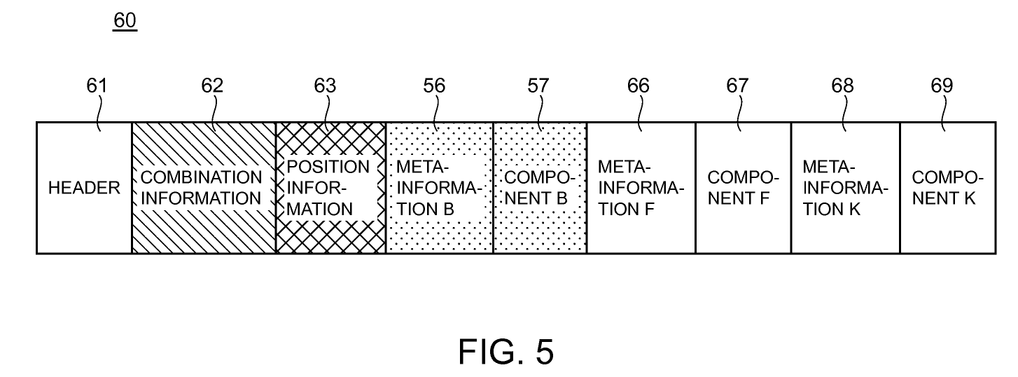

The package configuration apparatus 100 receives selection of components from a user and configures a package containing one or more components. The package configuration apparatus 100 configures the package by using components of the combination guaranteed by a person who primarily provided a software package (hereinafter, referred to as “primary provider”). This specification mainly describes an embodiment in which the package configuration apparatus 100 configures a private package 60 (see, e.g., FIG. 5), which is a secondary software package, with a single package 50 (see, e.g., FIG. 2), which is a primary software package. The package configuration apparatus 100, however, may configure the single package 50 or may be an apparatus used by a person who received the private package 60. The package configuration apparatus 100 has functions for processing information and it may be a computer.

It should be noted here that the component may be a software program, data, or the like. For example, one component may be an application program such as text generation software or may be data such as a library or a device driver or a software program. Furthermore, it may be a software program including a program for enabling a computer to boot from an error condition at the occurrence of the error or a program for error recovery. On the other hand, the package is a set of software components collected by combining the above one or more components. Specifically, the package is configured by a mediator through selecting given components from the provided single package.

The control section 110 is a central processor for computing and controlling information, which operates in the package configuration apparatus 100, and it may be a central processing unit (CPU). The control section 110 includes a combination determination section 111 for determining the combination of components, a package configuration section 112 for performing package configuration processing, and a verification section 113 for verifying a digital signature.

The combination determination section 111 determines the combination of the components selected by the user based on combination information. In this regard, the combination information is on the combination of the components contained in the package. Specifically, the combination information is on the combination allowed by the primary provider among the combinations of the components. The combination information may be, for example, data made of combined signatures of the components (hereinafter, referred to as “combination data”).

The package configuration section 112 configures a package as described later on the basis of a result of the determination of these combinations made by the combination determination section 111 for the components selected by the user.

The verification section 113 verifies the legitimacy of an object encrypted by the primary provider with a digital signature. The primary provider makes a digital signature (hereinafter, appropriately referred to as “signature”) to guarantee the content of a single package itself, respective components, combination information, position information, or the like (hereinafter, referred to as “single package or the like”). In order to guarantee that the single package or the like with the digital signature appended is not altered, the verification section 113 verifies the signature to verify that the content is a legitimate single package provided by the primary provider.

It should be noted here that the digital signature is a method of detecting alteration of the content of data provided by the primary provider with a combination of public key encryption and hashing, if the alteration occurs. Specifically, in the digital signature, data to be transferred is converted to a digest by hashing and the digest is encrypted with a private key to create a signature. The signature is provided to the user with data. Then, the user converts the provided data to a digest by hashing and compares the digest with a digest decrypted using a public key from the received signature. Thereby, only when the digests matches with each other, is the user is allowed to use the data in the method. In a general method of packaging or unpackaging software, the use of internal data is allowed only when the package is determined not to be altered as a result of the verification of the digital signature.

Concretely, the encryption technologies may be an RSA encryption technology or a DSA encryption technology used for a large number of encryption products for supporting electronic commerce or the like or may be an encryption technology based on a specification conforming to X.509, which is one of the standard specifications for electronic keys. Moreover, a hash algorithm used for authentication or for a digital signature may be Secure Hash Algorithm 1 (SHA-1).

Therefore, the primary provider makes a digital signature for a single package or the like and provides it to the user, whereby the user can use the single package or the like guaranteed in that it is not altered by a third party.

The input section 120 receives an input from the user to the package configuration apparatus 100. The input section 120 may be, for example, a keyboard, a pointing device, or the like. The input section 120 includes a component selection section 121. The component selection section 121 receives selection of components from the user.

It should be noted here that the user who selects the components may be a mediator (secondary or tertiary mediating provider) who handles the transaction of the package between the primary provider and the client. Moreover, the final user of information contained in the package may not be a secondary provider who obtains the single package directly from the primary provider, but may be a tertiary (higher order) provider who obtains the package from the secondary provider.

The package recording section 130 records the single package or the reconfigured package. The package recording section 130 may be a computer hard disk or the like.

Subsequently, the single package 50 provided by the primary provider will be described with reference to FIG. 2.

The single package 50 is provided before the user configures the package. In the description of the embodiment according to the present invention, the single package 50 is described as a package provided by the primary provider in order to clarify the description. However, it is not intended to limit the scope of the present invention.

The single package 50 has a header 51, combination information 52, and position information 53 and includes a component A (55) to a component X (59) to be selected by the user and meta-information A (54) to meta-information X (58) thereof. Here, the meta-information is not information the user wants to use ultimately, which is contained in the component, but information on the component itself. The meta-information may include the size of the corresponding component or a digital signature.

The header 51 includes digital signatures of the respective information in the single package 50. Specifically, the header 51 includes a signature of the single package 50 and signatures of the combination information 52, the position information 53, and the meta-information 54, 56, and 58. Moreover, the header 51 may include a public key for decrypting the signatures.

Moreover, when the header 51 is read out after it is encrypted with a digital signature, the verification section 113 may verify the header 51 using the signature. If this is the case, the primary provider provides the user with a header signature and a public key besides the single package 50 and the single package 50 is read out after the verification of the header 51. In this instance, the verification of the entire single package 50 is verified by verifying the header 51.

As described later, a digest is created using the signature and the public key included in the header 51, and the digital signature is verified using the digest created from the provided single package 50. For example, the digest of the combination information is created using the signature of the combination information and the public key included in the header 51, and then the digest is compared with the digest created from the combination information in the single package 50, whereby the digital signature is verified.

The combination information 52 describes combinations allowed by the primary provider of the single package among the combinations of the components. The combination information includes data made of combined signatures of the components (hereinafter, referred to as “combination data”) or a signature created for the combination data (combination signature).

The position information 53 includes information on physical positions (offset information or the like) where the components are stored. The position information is possible to change when the package is reconfigured.

The meta-information 54, 56, and 58 are on the components. For example, the meta-information A (54) includes the size and name of the component A (55) and the signature of the component A (55).

Note that, however, the header information and the meta-information of the single package 50 are intended to be stored in the package on a conceptual basis, but not intended to limit the physical arrangement in the package.

As described later, the digital signature may be verified by creating a digest of the combination information with the signatures of the combination information included in the meta-information 54, 56, and 58 and the public key included in the header 51 and comparing the digest with the digest created from the combination information in the single package 50, for example.

The primary provider who primarily provides a package configures the single package 50 by means of the package configuration apparatus 100. While the single package 50 and the private package 60 are configured by using the package configuration apparatus 100, which is the same hardware, in this specification, they may be configured by using different hardware.

In response to an input from the primary provider, the package configuration apparatus 100 configures the single package 50 using the header 51, the combination information 52, the position information 53, the meta-information A to X 54, 56, and 58, and the components A to X 55, 57, and 59 corresponding to the meta-information A to X 54, 56, and 58, respectively, as described above.

The primary provider creates the combination information 52 by using the package configuration apparatus 100. Specifically, the primary provider creates the combination of the components allowed by the primary provider as the combination information 52.

Then, the package configuration apparatus 100 performs processing of calculating the digital signatures of the components, processing of creating and recording the combination information 52 of the components, and processing of making a digital signature of the entire package.

Specifically, the package configuration apparatus 100 converts the selected components to digests using a hashing algorithm, encrypts the digests with a private key, creates signatures, and adds the signatures to the meta-information 54, 56, and 58 of the components in order to calculate and record the digital signatures of the components.

Furthermore, the package configuration apparatus 100 converts the combination information 52 to a digest using hashing, encrypts the digest with a private key, creates a signature, and adds the signature to the header 51 of the single package 50.

In addition, the package configuration apparatus 100 makes the digital signature of the entire package by converting the single package 50 to a digest using hashing, encrypting the digest with the private key, creating a signature, and adding the signature to the header 51 of the single package 50.

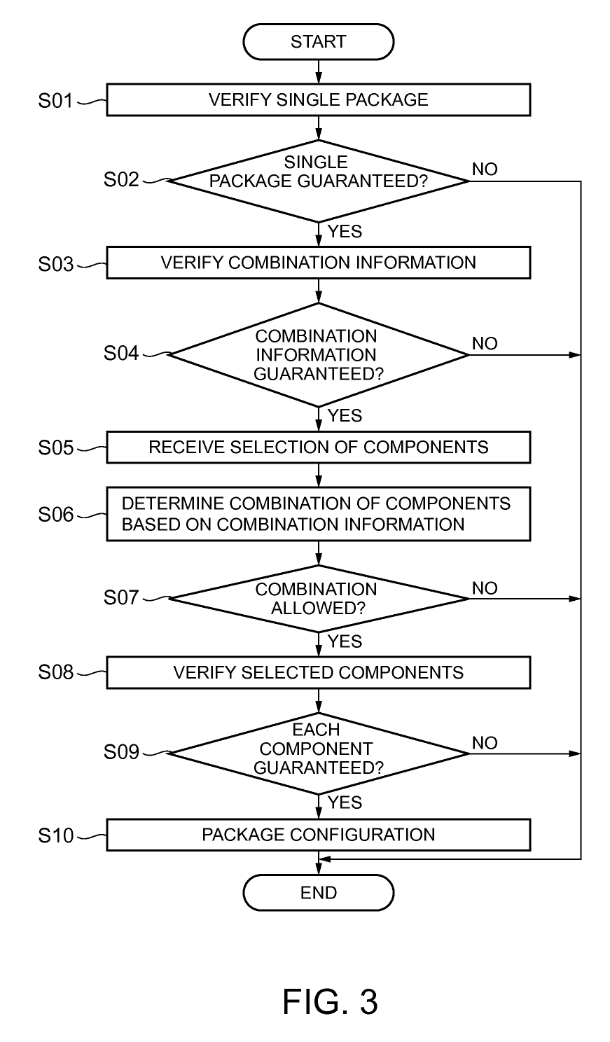

An illustrative operation of the present invention will be described with reference to the flowchart shown in FIG. 3, in which the package configuration apparatus 100 configures the private package 60 from the single package 50 configured as described above. While the following mainly describes that the package configuration apparatus 100 configures the private package 60 from the single package 50, the embodiment may be such that the private package 60 is configured from the single package 50 and then the private package 60 is reconfigured.

First, the verification section 113 verifies the single package 50 (step S01). Specifically, the verification section 113 verifies the provided single package 50 to guarantee that the single package 50 is not altered until the user is provided with the single package 50.

When the verification section 113 verifies the single package 50, the primary provider provides the user with a signature of the entire single package 50 and a public key. The signature and the public key may be included inside the package or may be provided separately from the package. Using the signature and the public key, the verification section 113 verifies whether or not a third party altered the entire single package 50.

The verification section 113 decrypts the signatures included in the header 51 with the public key and converts them to a digest. The verification section 113 verifies the legitimacy of the single package 50 by comparing the digest with a digest created by converting the single package 50 using hashing.

If the verification section 113 determines that the single package 50 is guaranteed by the primary provider, the verification section 113 verifies the combination information 52 by using the signature (steps S02 and S03). If the verification section 113 determines that the single package is not guaranteed by the primary provider, but could have been altered by a third party, the processing terminates.

If the verification section 113 determines that the single package 50 is guaranteed by the primary provider, the verification section 113 verifies the combination information 52 recorded in the single package 50 by using the signature of the combination information recorded in the header 51 (step S03).

The verification section 113 decrypts the signatures included in the header 51 with the public key and converts them to a digest. The verification section 113 verifies the legitimacy of the combination information 52 by comparing the digest with a digest created from the combination information 52 included in the single package 50 using the hashing algorithm.

If the verification section 113 determines that the combination information 52 is guaranteed by the primary provider, the combination determination section 111 receives a list of the selected components (steps S04 and S05). If the verification section 113 is unsuccessful in the verification and determines that the combination information 52 is not guaranteed by the primary provider, but could have been altered by a third party, the processing terminates.

The component selection section 121 receives user's selection of components (step S05).

Subsequently, the combination determination section 111 determines that the combination of the components selected by the user on the basis of the combination information 52 (step S06). For example, the component selection section 121 creates a list of the components selected by the user. Then, the combination determination section 111 may determine the combination by comparing the list with the combination information 52. The combination information 52 includes data made of the collected signatures of the components of the combination (“combination data”) as described later. Furthermore, the combination information includes a signature created from the combination data (hereinafter, referred to as “combination signature”) in order to guarantee the combination data. The verification section 113 verifies the combination data and the combination determination section 111 compares the combination data with the above list to determine the combination. At this point, the combination signature is used to guarantee the legitimacy of the combination data. Specifically, the verification section 113 verifies the legitimacy of the combination data by using the combination signature. Thereby, the verification section 113 verifies both of the combination information 52 itself and the combination data in the combination information.

If the combination determination section 111 determines that the combination of the components is allowed by the primary provider, the verification section 113 verifies the respective components with the digital signatures (steps S07 and S08).

On the other hand, if the combination determination section 111 determines that the combination is not allowed by the primary provider, the package configuration is not allowed by the primary provider and therefore the processing terminates. In this instance, the combination determination section 111 may notify the user that the combination is not allowed by the primary provider. Specifically, the package configuration apparatus 100 may display the information that the combination not allowed by the primary provider has been selected on the output device of the package configuration apparatus 100.

Subsequently, the verification section 113 verifies the legitimacy of the components selected for the combination among the components recorded in the single package (step S08).

The verification section 113 decrypts the signature included in the meta-information 54 with the public key and converts it to a digest. It verifies the legitimacy of each of the components by comparing the digest with a digest created by converting each of the components included in the single package using the hashing algorithm.

If the verification section 113 determines that the component is guaranteed by the primary provider, the package configuration section 112 performs package configuration processing (steps S09 and S10). If one or more of the selected components are unsuccessfully verified with the digital signatures and it is determined that they could have been altered by a third party, the relevant components are determined to have a problem and the processing terminates.

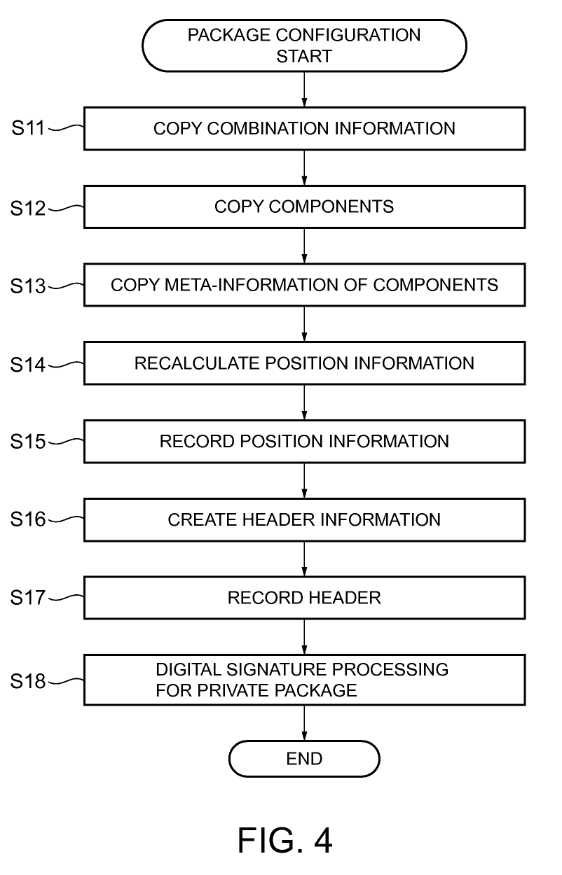

Subsequently, the package configuration processing will be described with reference to FIG. 4 and FIG. 5.

Referring to FIG. 4, there is shown a flowchart of the package configuration processing performed by the package configuration section 112. Referring to FIG. 5, there is shown a package 60 (hereinafter, referred to as “private package”) composed of the single package 50 shown in FIG. 2. The package configuration section 112 copies the combination information 52 of the single package 50 onto the private package 60 (step S11).

Specifically, the combination information 52 need not be changed between the single package 50 and the private package 60. That is because the user needs to carry over the combination information 52 guaranteed by the primary provider who configured the single package 50 and, at the time of further reconfiguration of the private package 60 created by the user, it is necessary to reconfigure the private package 60 based on the combination guaranteed by the primary provider.

Therefore, the private package 60 can be limited to the combination of the components within the range guaranteed by the primary provider for the package reconfiguration of the private package 60 by taking over the combination information guaranteed by the primary provider. If a malicious mediator attempts to create personal combination information not allowed by the primary provide here, the package user can detect that the combination information created in such a manner is not legitimate by verifying the digital signature of the combination information.

Subsequently, the package configuration section 112 copies the components selected by the user and their meta-information from the single package 50 to the private package 60 (steps S12 and S13). Thereafter, the position information is recalculated since the physical locations of the components change due to the reconfiguration into the private package 60 (step S14). The recalculated position information is recorded as position information 63 into the private package 60 (step S15).

Subsequently, the package configuration section 112 creates information on a header 61 (step S16) and records it into the private package 60 (step S17). The information of the header 51 includes a signature of the single package 50, a signature and a public key of the combination information 52, a signature and a public key of the position information 53, and signatures and public keys of the meta-information 54, 56 to 58. The package configuration section 112 creates the header 61, which differs from the header 51. The combination information 52 and the combination information 62 are similar to each other and therefore the information of the header 61 includes a signature and a public key of the combination information 62.

The package configuration section 112 adds the signatures and public keys of the meta-information 54, 56, and 58 of the selected components to the information of the header 61. Furthermore, the package configuration section 112 adds the signature and public key of the recalculated position information 63 to the information of the header 61. The package configuration section 112 records the header 61 created in this manner into the private package 60.

Lastly, the package configuration section 112 performs digital signature processing for the configured private package 60 (step S18). As described above, the package configuration section 112 may create a signature of the header 61 and thereby perform the digital signature processing of the entire package.

The package configuration processing shown in FIG. 4 is illustrative only and it will be apparent to those skilled in the art that the private package 60 is ultimately configured even if the order of the processing steps varies. Moreover, the embodiment may be such that the combination information is determined to be guaranteed by the determination of the guarantee to the single package, thereby omitting the verification of the combination information (steps S03 and S04).

FIG. 5 shows the private package 60 configured with a component B (57), a component F (67), and a component K (69) as an example. The component selection section 121 receives selection of the components from the user. Then, the combination determination section 111 determines combinations of the components based on the combination information. If the combination determination section 111 determines that the combination of the component B (57), the component F (67), and the component K (69) is guaranteed by the primary provider on the basis of the combination information describing the combinations guaranteed by the primary provider, the components and meta-information 56, 66, and 68 corresponding to the components are recorded into the private package 60.

Thereafter, a signature of the entire private package and a public key of the signature may be included in the header 61 with a digital signature made for the private package 60.

Similarly to the single package 50, the header information and the meta-information of the private package 60 are intended to be stored in the package on a conceptual basis, but not intended to limit the physical arrangement in the package.

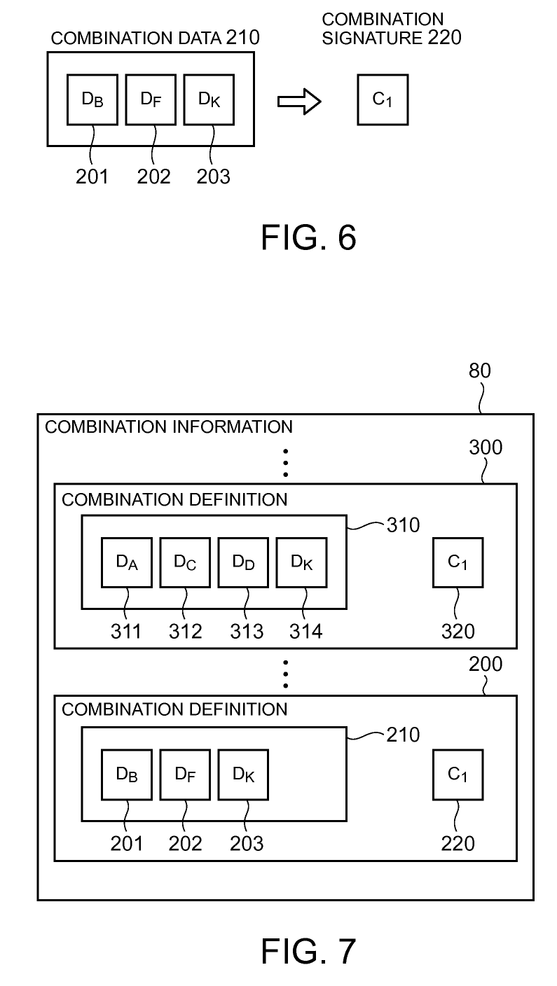

The combination information will be described in detail hereinafter with reference to FIG. 6. The combination information may be composed of “combination data,” which is data made of collected signatures of the components of the combination. Specifically, the combination data may be data made of the collected digital signatures of the plurality of components of the combination guaranteed by the primary provider. As shown in FIG. 6, if the combination of the component B, the component F, and the component K is allowed by the primary provider, data made of collected digital signatures 201, 202, and 203 of the components is shown as combination data 210. Specifically, in FIG. 6, the digital signatures of the component B, the component F, and the component K correspond to D_{B} 201, D_{F} 202, and D_{K} 203, respectively. This kind of combination data 210 are included in the combination information by the number of the combinations guaranteed by the primary provider.

Moreover, a combination signature 220 corresponding to one combination data among the combination data may be provided to guarantee the combination data 210. In this instance, the verification section 113 verifies the combination data 210 with the combination signature 220. Specifically, the verification section 113 verifies both of the combination information 52 itself and the combination data 210 in the combination information.

As shown in the example of FIG. 7, combination definitions 200 and 300 are data each composed of information on one combination of the components. Specifically, the combination definition 200 is composed of the combination data 210 and the combination signature 220. The combination definition 300 is composed of the combination data 210 and a combination signature 320. Combination information 80 includes a plurality of combination definitions 200, 300, and so on.

Thereafter, the combination determination section 111 compares each combination data recorded in the combination information with the combination of the selected components (hereinafter, referred to as “selected combination”). In this regard, the combination determination section 111 may determine the selected combination by comparing a list of the names of the combined components, which is provided in the combination data, with the selected combination.

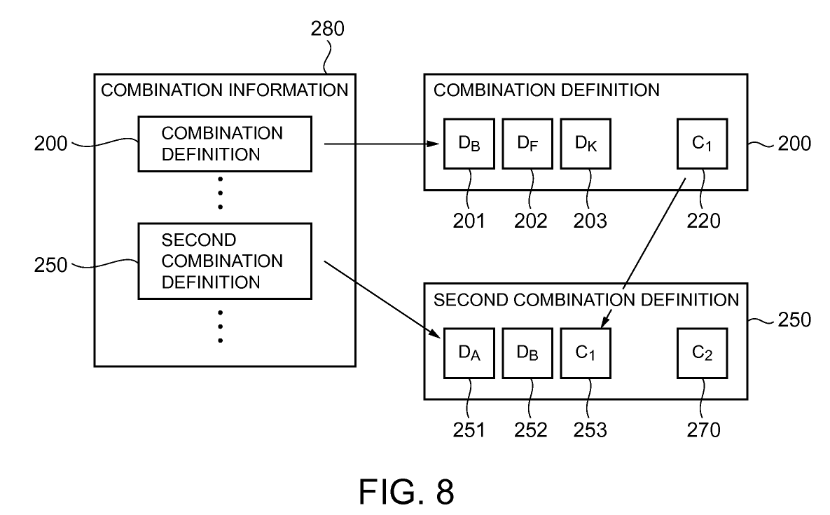

As a variation here, the package configuration section 112 may make a second combination definition by further adding one combination signature to another combination data as shown in FIG. 8. Specifically, the package configuration section 112 may make the second combination definition 250 including the combination signature 220 of the combination data 210. If this is the case, the digital signature of the second combination definition 250 does not need to include the digital signatures 201 to 203. Therefore, the second combination definition 250 can be downsized, whereby the amount of the combination information 280 can be reduced.

While it may be employed to configure the combination information with the nested combinations as described above when the package configuration section 112 receives an input from the user and configures the private package 60, the single package 50 provided by the primary provider may have this type of data structure.

Moreover, in this specification, it has been described that the single package 50 is a package provided by the primary provider at the beginning and the private package 60 is a package configured by the secondary provider in order to discriminate between the single package 50 and the private package 60. It will be apparent to those skilled in the art, however, that the single package 50 in this specification corresponds to a secondary private package 60 when a tertiary private package 60 is configured based on the secondarily configured private package 60.

A package configuration method for achieving the above embodiment can be performed by using a program to be executed by a computer or a server. As a storage medium for the program, an optical storage medium, a tape medium, a semiconductor memory, or the like is available. Alternatively, by using a storage device such as a hard disk or a RAM provided in a server system connected to a private communication network or the Internet as a storage medium, the program may be provided over the network.

While the preferred embodiment of the present invention has been described hereinabove, it is to be understood that the illustrative embodiment has been provided merely for the purpose of explanation with examples and it is not intended to particularly limit the present invention. Moreover, the effects described in the embodiment of the present invention have been enumerated merely as the most preferable effects achieved by the present invention, but the effects of the present invention are not limited to those described in the embodiment of the present invention.

1. A method for reconfiguring a software package, wherein a primary software package contains a plurality of components and combination information indicating allowed combinations of the components, the method comprising:
receiving a selection of a certain combination among the plurality of components;
determining whether a reconfiguration of the software package using the selected components should be allowed based on the combination information; and
reconfiguring a secondary software package containing the selected components in compliance with the determination.

2. The method according to claim 1, wherein the combination information is carried over to the secondary software package.

3. The method according to claim 1, wherein the allowed combination is decided by a primary provider and the certain combination is selected by a secondary provider.

4. The method according to claim 1, further comprising verifying each of the components of the selected combination with a digital signature corresponding to each of the components.

5. The method according to claim 1, further comprising verifying a legitimacy of the selected combination using a digital signature corresponding to the combination information among the components.

6. The method according to claim 1, further comprising providing a digital signature for the reconfigured secondary software package.

7. The method according to claim 1, wherein the primary software package contains position information indicating physical locations where each component is stored.

8. The method according to claim 1, wherein reconfiguring the secondary software package includes reconfiguring the secondary software package containing the components of the selected combination and the combination information.

9. A apparatus for reconfiguring a software package, wherein a primary software package contains a plurality of components and combination information indicating allowed combinations of the components, the apparatus comprising:
a selection system for receiving a selection of a certain combination among the plurality of components;
a determination system for determining whether a reconfiguration of the software package by the selected components should be allowed based on the combination information; and
a configuration system for reconfiguring a secondary software package containing the selected components in compliance with the determination.

10. The apparatus according to claim 9, wherein the combination information is carried over to the secondary software package.

11. The apparatus according to claim 9, wherein the allowed combination is decided by a primary provider and the certain combination is selected by a secondary provider.

12. The apparatus according to claim 9, further comprising:
a system for verifying each of the components of the selected combination with a digital signature corresponding to each of the components.

13. The apparatus according to claim 9, further comprising:
a system for verifying a legitimacy of the selected combination using a digital signature corresponding to the combination information among the components.

14. The apparatus according to claim 9, further comprising:
a system for providing a digital signature for the reconfigured secondary software package.

15. The apparatus according to claim 9, wherein the primary software package contains position information indicating physical locations where each component is stored.

16. The apparatus according to claim 9, wherein the configuration system for reconfiguring the secondary software package includes:
a system for reconfiguring the secondary software package containing the components of the selected combination and the combination information.

17. A data structure on a computer-readable recording medium, comprising:
at least one component of a software package; and
combination information including combination data and a combination definition for each allowable combination of the at least one component of the software package, each combination definition including a digital signature from a provider of the software package.

18. The data structure according to claim 17, wherein the combination information includes a second combination definition in which the digital signature of the combination data is included in another combination data.
